(19) United States
(12) Patent Application Publication
(10) Pub. No.: US 2016/0286769 A1
(43) Pub. Date: Oct. 6, 2016

(54) Fishing Lure with Improved Features for More Realistic Behavior

(71) Applicant: Matthew P. Stark, Morris Plains, NJ (US)

(72) Inventor: Matthew P. Stark, Morris Plains, NJ (US)

(21) Appl. No.: 14/674,768

(22) Filed: Mar. 31, 2015

(51) Int. Cl. A01K 85/00; A01K 85/16

(52) U.S. Cl. CPC A01K 85/00; A01K 85/16; A01K 2227/40

(57) ABSTRACT

A soft fishing lure that is comprised of a body, body core, appendages, and claws, which incorporate features to better emulate the life-like attributes, movements, and behaviors of live bait. The present invention strategically integrates ridges, lips, air traps, and current vanes to manipulate hydrodynamic pressure to achieve an advanced style of movement and behavior, which closer resembles that of kinetic muscle movements possessed by living organisms.

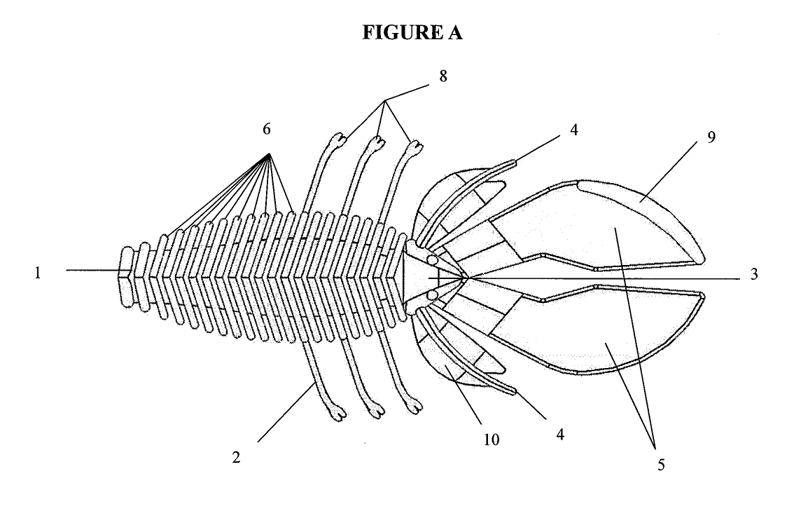

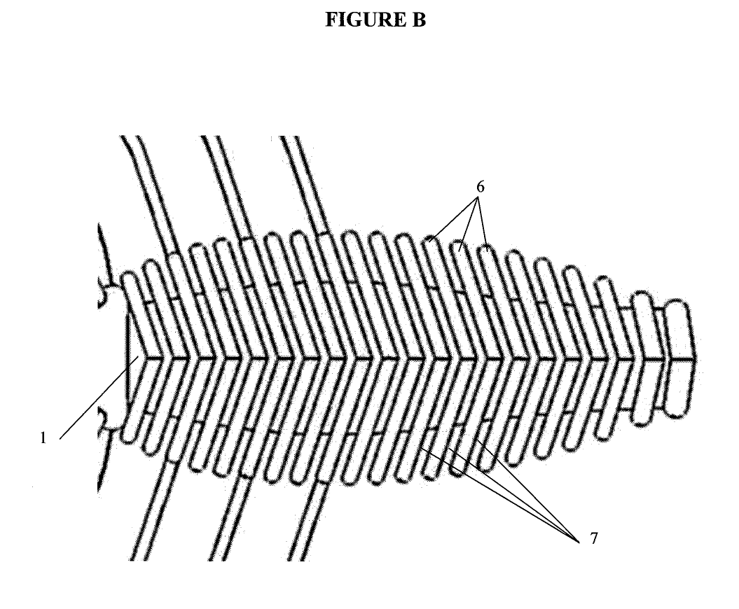

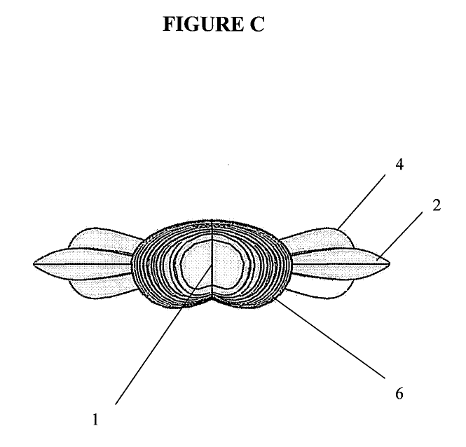

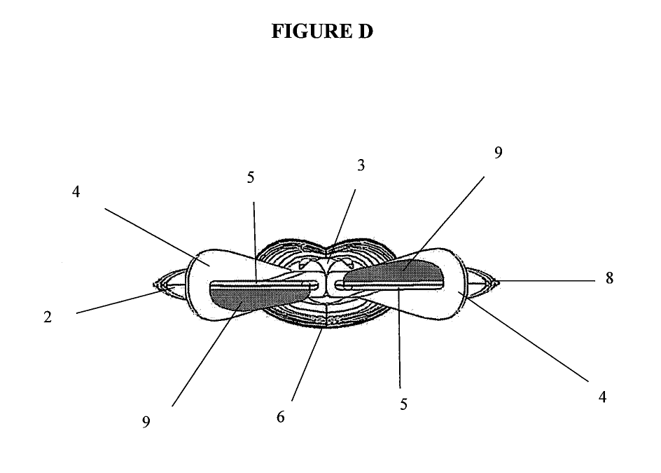

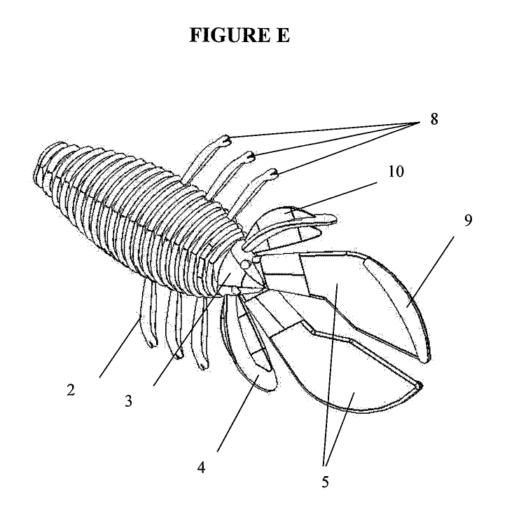

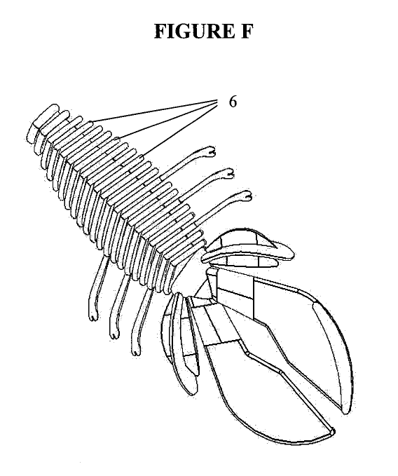

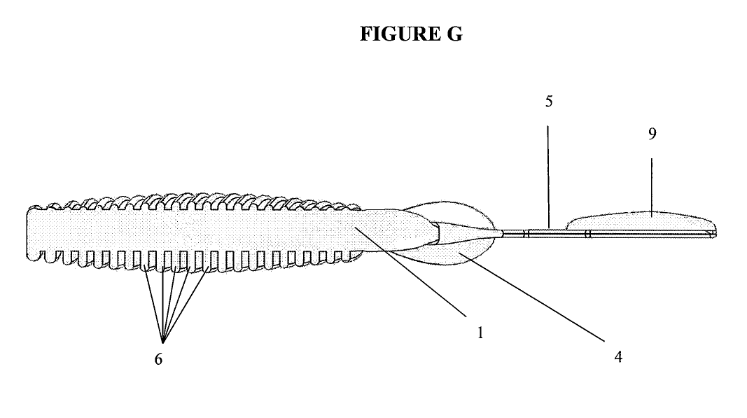

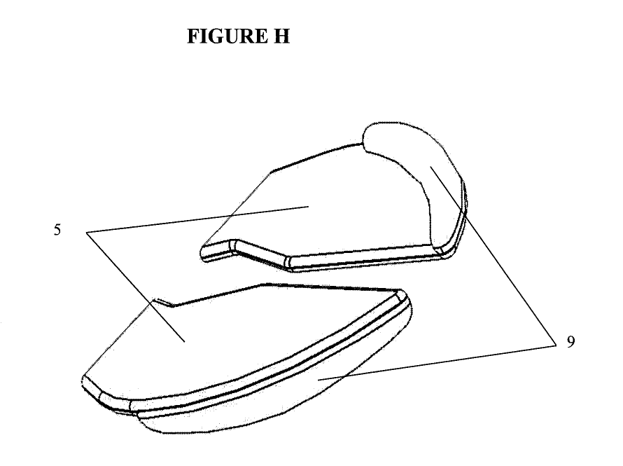

### CLAIM OF BENEFIT OF A PRIOR-FILED APPLICATION UNDER 35 U.S.C. 119(E)

This nonprovisoinal application claims benefit under 35 U.S.C. 119(e) to provisional application No. 61/972,576 filed on Mar. 31, 2014.

### FIELD OF THE INVENTION

The invention generally relates to fishing and more particularly, improved fishing lures that can be used to attract fish.

### BACKGROUND OF THE INVENTION

While artificial fishing lures have been known in the field for many years, there is always a need and want to improve the current technology of fishing lures to achieve better results. Sport fishing has quickly grown into one of the largest outdoor sporting activities in America. Every year thousands of sponsored contests draw millions of participants and spectators. As the sport continues to grow, so does the nature of competition within the sport. Accordingly, anglers are in constant search of the next product that can give them an edge over their competition.

It is generally agreed upon within the field that the more natural and life-like a lure looks, the more effective it will be at attracting fish. For this purpose, lures are often molded to resemble small insects, fish, amphibians, and other natural sources of food for fish. In an effort to further increase effectiveness, life-like attributes, such as artificial movement, are also incorporated into prior art. Prior art evidences an extensive history of lures that have attempted to employ life-like attributes in a number of ways, all of which, while successful at advancing the prior art in the field, still fall short of creating an undeniable impression of life-like movement.

With that said, there remains a continued need and growing demand to make artificial lures and artificial baits more realistic in this field. Through the integration of purposefully designed features, derived from proven theories of natural science, the present invention drastically advances technology in this field.

The specially designed features of the present invention significantly improve the life-like and realistic movement and behavior of lures in the water. These novel features permit an artificial lure to more closely emulate the movements and behaviors of live bait, thus, uniquely and significantly improving the art beyond what is currently available. The present invention can also be quickly manufactured and produced in a cost efficient manner to satisfy the current market demand.

### SUMMARY OF THE INVENTION

The present invention can be referred to as an artificial or man-made fishing lure that can be made of soft, neutrally-buoyant plastics, and/or sinking plastics, and/or rubbers. One embodiment of the present invention is comprised of a body, a body core, front and rear appendages, claws, a head, and chevron-shaped external ribs.

A primary objective of the present invention is to closer emulate the life-like movements and behaviors of living organisms upon which fish naturally feed. In order to accomplish this objective, the present invention may implement a body with chevron-shaped external ribs, which can create serrated air traps for naturally capturing and releasing air bubbles while the lure is in movement under the water. The serrated air traps of the present invention may be created by incorporating at least two individually-separated ribs and/or ridges, which leave air space by at least partially protruding from the body core of the lure in a circumferential fashion.

To further accomplish this objective, the present invention may also integrate an alternating ridge-lip design into, or onto, the claws and/or appendages of the fishing lure. The incorporation of an alternating ridge-lip design onto opposing or contra-positioned appendages, and/or claws, will allow the lure to effectively utilize hydrodynamics to manipulate the movements of its appendages, and/or claws, to simulate a kinetic muscle movement, akin to kicking.

The alternating ridge-lip design may appear as an outward protrusion incorporated into, and/or onto, the outward, inward, and/or planar surface, and/or edges, of at least one of the claws or appendages. In addition, the at least one lip/and or outwardly protruding ridge may run at least partially the length of said claw and/or appendage. These ridges and/or lips can be on at least one of the said claws and/or appendages, and the said ridges and/or lips can be contra-positioned onto alternating sides of adjacent appendages and/or claws.

To yet further aid in this objective, the present invention may additionally incorporate appendages that utilize at least two unidirectional vanes to catch and/or drag against water currents to provide constant but subtle appendage movement, even when the lure is not being manipulated by the user. Any of the appendages may be purposefully designed to manipulate hydrodynamics to lay flat against the body of the bait as it moves through vegetation and slowly flower open as the lure becomes still.

### BRIEF DESCRIPTION OF DRAWINGS

Figure A depicts a perspective frontal view of the invention. This figure depicts several of the main features of the invention from an overhead perspective. Several of the features shown include the solid body core (1) which runs throughout the length of the body of the invention; the individually separated exo-ribs (6), which are shown chevron-shaped and protruding in a circumferential fashion around the body core (1); the rear appendages (2) which are attached to, and extending from, several of the exo-ribs (6); the fork-tipped ends (8) of the rear appendages (2); the front-appendages (4) and their incorporated current vanes (10); the invention's front claws (4) and one visible alternating ridge-lips (9) that is incorporated onto the top facing surface of the invention's left claw in this particular embodiment.

Figure B is an isolated close-up of the invention's body depicting in closer detail the invention's body core (1) and the individually separated exo-ribs (6), as well as the air traps (7) between the invention's exo-ribs (6).

Figure C depicts a rear perspective of the invention. In this figure the invention is in a downward facing position, this is made ascertainable by the shape that the exo-rib(s) protrude from the body core (1). This view better illustrates the chevron-shaped arrangement of the invention's individually separated exo-ribs (6) around the body core (1). It can be seen that the exo-ribs on the bottom of this figure (which is in actuality the top of the invention) draw in close to the bottom center of the body core (1) so as to form an inward “v” shape, as differentiated from the exp-ribs (6) on the top of the figure (which is in actuality the bottom of the invention). Also shown in this image is the horizontal and vertical alignment of the front appendages (4) in relation to rear appendages (2).

Figure D shows a head-on perspective of the invention. In this figure the top surface of the invention is facing upwards. This figure depicts the invention's contra-positioned protruding ridge-lips (9) which are incorporated onto the opposing outer surfaces of the claws (5), the alternating ridge-lips (9) are depicted shaded in this figure. This figure also depicts the vertical and horizontal alignment and exposure of the claws (5), front-appendages (3) and rear appendages (2).

Figure E depicts an top-side isometric view of the present invention which illustrates the current vanes (10) on the front appendages (4), as well as the fork-tipped ends (8) incorporated onto the rear appendages (2). Further depicted within this figure is one of the ridge-lips (9) which is shown on the top outer surface of the left claw (5). This figure also shows the topside orientation of the exo-ribs (6) which are circumferential shaped.

Figure F is an isometric view of the underside of the invention that depicts the exo-ribs (6) coming in against the body core to form a chevron shape. Figure F shows the opposing ridge-lips (9) which is now shown on the alternate side of the alternate claw (5).

Figure G is a dissected side view depicting the left half of the invention. This figure serves to illustrate the horizontal orientation of the invention, including the alignment of the individually separated exo-ribs (6) protruding from the solid body core (1), and the height of the front appendages (4), as well as the general vertical height of a ridge-lip (9) from a claw (5).

Figure H is a segmented isometric view of the invention's alternating ridge-lip (9) design which is incorporated into the lure's claws (5). This isometric view depicts the opposing ridge-lips (9) on the opposing diametric sides of the left and right claw.

### DETAILED DESCRIPTION

The present invention is a flexible artificial fishing lure. Figures A, E and F depict perspective views of the present invention in its entirety. An embodiment of the present invention is comprised of the body core of the lure (1); rear appendages (2); the head of the lure (3); front appendages (4); claws (5); and exo-ribs (6). In addition, several of these elements incorporate specific features which add to the invention's functionality. These features include: current vanes (10), fork-tipped appendage ends (8); air traps (7); and alternating ridge-lips (9).

The body of the invention is comprised of a solid body core (1) which is a flexible oval mass that runs throughout the length of the body up until the head (3) of the invention. The body is further comprised of a series of individual exo-ribs (6). These exo-ribs (6) protrude from the body core and extend therefrom, forming a three-dimensional, chevron-shaped, circumferential perimeter around the body core. Figure B is a magnified frontal perspective illustrating the body of the lure in further detail. The positioning and design of the exo-ribs (6) in relation to the body core (1) is instrumental to several key utility features of the present invention and can be seen in closer detail in Figure B.

The exo-ribs (6) being individual and directly isolated from one another, protruding a distance from the body core (1) and being chevron-shaped, allow the present invention to accomplish two important objectives. One, the chevron shape of the individually protruding exo-ribs provides a significantly improved grip for a biting fish. Thus permitting a fish to do more than merely bite down onto a lure, they allow a fish to bite into the lure, beyond and through the exo-ribs (6) down to the solid body core (1). This creates a more realistic feel for a biting fish, as well as better leverage and grip for the fish. This translates into a more aggressive bite and, more importantly, a more aggressive biting sensation felt by the fisherman greatly increasing reaction time and the odds of setting the hook.

Secondly, the aforementioned incorporated features depicted within Figure B create a one-of-a-kind action, which allows the lure to closer resemble that of a living amphibian or insect compared to prior art. As fish are instinctively attracted to live natural food, the present invention intermittently releases air bubbles to emulate the realistic pulmonary behavior of an oxygen-breathing amphibian or insect whilst underwater. The integration of individual exo-ribs (4), which are chevron-shaped, create air traps (7) when the lure is cast and quickly submerged. These chevron-shaped individually separated exo-ribs (6) temporarily capture and hold air pockets between them which sporadically escapes as the lure is reeled or manipulated throughout the water, thus purposefully bringing attention to the lure making it appear as if the lure is a natural-living, oxygen-breathing, food source.

Also incorporated into the body of the present invention and depicted in Figures A, E and F are rear appendages (2). Several rear appendages are illustrated protruding from the sides of the body, and directly extending from, and being attached to the exo-ribs (6). In Figure E, the rear appendages can be seen to include forked-tips (8). These fork-tipped rear appendages, as well as the star-winged (10) front-appendages (4), are specially designed to act as current vanes. This star-winged design (10), and fork-tipped (8) design, creates multidirectional surfaces for which these front and rear appendages can effectively catch and drag against under water current(s), regardless of which direction the current is moving. The purpose of these features is to further simulate natural life-like movements of live bait. This features broadens the user's options when fishing. Now a fisherman can leave, what was prior to this invention, a traditional reeling lure alone in the water as a bait. Similar to bait fishing with a worm or other live-bait, which would simply be tossed and left, this lure will also move on its own and subtly attract less-aggressive fish while left idle underwater, such interoperability is a significant advancement to prior art in this field.

Figure H is a segmented isometric view of the invention's alternating ridge-lip (9) design which is incorporated into the lure's claws (5). This isometric view depicts the opposing ridge-lips (9) on the opposing diametric sides of the left and right claws, respectively. The present invention incorporates these strategically integrated alternating ridge-lip designs to manipulate the movements of the claws while the lure is pulled through the water. The alternating ridge-lips are protrusions which extend outwardly from the edges along the outermost planar surfaces of the claws and create opposing hydrodynamic drag. These ridge-lips are purposefully contra-positioned on the left and right claws to achieve a natural alternating kinetic movement, as exerted by living organisms. In the figures depicted the alternating ridge-lips are placed on top of the invention's right claw and the underside of the invention's left claw, however, these positions can be switched and/or integrated elsewhere on another embodiment of the current invention of the lure and achieve the same desired effect.

Figure F illustrates the star-winged designs (10) that are incorporated into the front appendages (4), as well as a rear isometric view of both the right and left rear claws (5). Also depicted is the raised ridge-lip on the outer edge on the rear side of the left claw (9), and the smooth surface along the outer edge on the rear side of the right claw (5). The vertical height of the front appendages (4) and the alternating raised ridge-lips (9) are shown in spatial relation to the body core (1), exo-ribs (6) and claws (5) of the lure and are more clearly depicted in Figure D and Figure G. Also shown in Figure G is the solid body core (1) of the invention and its spatial placement and incorporation into the lure, as well as the relative thickness of the invention's claw (5) in relation to the raised ridge-lips (9).

In this embodiment of the present invention the star-winged (10) front appendages (4) are shown of equal height with that of the claw's (5) alternating raised ridge-lip (9). These star wings (10) serve as additional current vanes that catch and drag against water current regardless of whether or not the user manipulates the lure, further contributing to greater lure action.

The alternating ridge-lip design (9) utilizes hydrodynamics to effectively create an alternating kicking motion between the opposing claws, thus further simulating a natural, life-like, realistic kinetic muscle movement. Acting alone, or in concert with the aforementioned features of this invention, this alternating movement significantly increases the lures resemblance of natural swimming patterns of living organisms.

While the invention has been particularly shown and described with reference to preferred embodiments thereof; it will be understood by those skilled in the art that the foregoing and other changes in form and details may be made therein without departing from the spirit and scope of the invention.

What is claimed is:

1. An artificial or man-made fishing lure comprising:
soft, semi-buoyant plastic having:
A body with two ends, wherein the body has a horizontal width and length and a vertical height, the body width being less than the body horizontal length and greater than the body vertical height;
A solid body core that starts at the rear of the body and continues throughout the body up until a head, and wherein the solid body core has a multitude of individual chevron-shaped elements that circumferentially protrude from it forming a series of individually separated exo-ribs around the body core;
At least one appendage(s) protruding from the solid body core of the lure, and/or protruding from and/or being attached thereto the exo-ribs and/or the head attached and/or directly extending from the solid body core;
A head with at least one appendage directly attached thereto and/or directly extending therefrom, wherein the at least one appendage directly attached thereto and/or directly extending therefrom has at least two protruding planar surfaces that are multidirectional and consist of at least one directional surface being of an upward and/or downward vertical height greater than that of the upward and/or downward vertical height of the head and exo-ribs of the invention;
At least two frontal claw-like appendages directly attached to and extending from the head of the lure, and the at least two claw-like appendages each having at least one diametrically raised outside lip on its top or bottom surface that is located on the opposing vertical surface of the claw-like appendage as that of the diametrically raised outside lip on the at least one other claw-like appendage.

2. The invention of claim 1 wherein the chevron-shaped individually separated exo-ribs are serrated and arcuate on the underside of the lure and tapered inwards to the body core on the top side of the lure.

3. The invention of claim 1 wherein the body core incorporates at least two circumferentially protruding, individually-separated, ribs and/or ridging.

4. The invention of claim 1 wherein the at least one appendage(s) are protruding from the body, body core, and/or the chevron-shaped, individually-separated ribs and/or ridging.

5. The invention of claim 1 wherein the head incorporates at least one attached, protruding appendage.

6. The invention of claim 1 wherein said body core is at least partially surrounded by at least partially circumferential protruding ribs and/or ridges.

7. The invention of claim 1 wherein the at least two circumferentially protruding, individually-separated ribs and/or ridging are spatially positioned so as to leave air space available between one another and up unto the body core.

8. The invention of claim 1 wherein said appendages incorporate at least two unidirectional vanes that protrude outwardly from the appendages.

9. The invention of claim 1 wherein the appendages attached to the exo-ribs lay flat against the body of the bait when submersed and reeled through the water.

10. The invention of claim 1 wherein the appendages slowly flower open as the lure becomes still, subtly shimmying even in stagnant water.

11. The invention of claim 1 additionally comprising an alternating ridge-lip design on at least two claws and/or appendages.

12. The invention of claim 11 wherein the alternating ridge-lip design utilizes hydrodynamic pressure to create the appearance of alternating kinetic movement.

13. The invention of claim 11 wherein the alternating ridge-lip design is an outward protrusion incorporated into and/or onto, the outward, inward, and/or planar surface, and/or edges of the claws or appendages.

14. The invention of claim 11 where there are at least two claws, each of which having at least one lip and/or outwardly protruding ridge run at least partial length of said claw and/or appendage.

15. The invention of claim 14 whereby said ridge and/or lip is raised from the rest of said claw and/or appendage to create a build-up of hydrodynamic pressure under said lip and/or ridge.

16. The invention of claim 14 whereby said ridges and/or lips are on both, or at least one of, the said claws and/or appendages, but said ridges and/or lips are contra-positioned onto alternating sides from any adjacent claw and/or appendage.
